(19) United States
(12) Patent Application Publication
(10) Pub. No.: US 2017/0193598 A1
(43) Pub. Date: Jul. 6, 2017

(54) POST-LENDING CREDIT MANAGEMENT

(71) Applicant: International Business Machines Corporation, Armonk, NY (US)

(72) Inventors: Miao He, Beijing (CN); Hao Ji, Beijing (CN); Chang Rui Ren, Beijing (CN); Ning Sun, Beijing (CN); Ming Xie, Beijing (CN); Jian Xu, Beijing (CN); Wen Jun Yin, Beijing (CN); Xiu Fang Zhu, Beijing (CN)

(21) Appl. No.: 14/985,663

(22) Filed: Dec. 31, 2015

(51) Int. Cl. G06Q 40/02

(52) U.S. Cl. CPC G06Q 40/025

(57) ABSTRACT

An aspect of post-lending credit management includes collecting data associated with events for a plurality of clients, serializing the data by time stamp and value to produce a client-based time series of the events, and performing feature generalization for the time series. Feature generation includes grouping the client-based time series according to a selected feature to produce feature-based time series, defining a feature-based default burst and a threshold value for the feature-based time series, identifying a point in time on the feature-based time series when the feature-based default burst reaches the threshold value, determining a cause and effect relationship between default events occurring across the plurality of feature-based time series from the feature-based default burst, and outputting feature-based default rules from the corresponding cause and effect relationship. An aspect also includes predicting an occurrence of a default event and time for a particular client from results of the feature generalization.

### BACKGROUND

The present invention relates generally to bank management systems and, more specifically, to post-lending credit management.

Banks attach great importance to post-credit lending management practices. The ability of a business customer to honor a credit agreement over the life of the agreement can be affected by many different factors, such as changes particular to the customer (e.g., reduction in the amount of business productivity), and/or changes in the environment (e.g., other industries impacting the customer experience financial issues).

### SUMMARY

According to one embodiment of the present invention, a method for post-credit lending management is provided. The method includes collecting data associated with events for each of a plurality of clients. Each of the events is associated with a corresponding one of the plurality of the clients. The method includes serializing, for each of the plurality of clients, the data by time stamp and value to produce a client-based time series of the events, and performing feature generalization for the client-based time series. The feature generation includes grouping each of the client-based time series according to a selected feature to produce a plurality of feature-based time series, defining a feature-based default burst and a threshold value for the feature-based time series, identifying a point in time on the feature-based time series when the feature-based default burst reaches the threshold value, determining a cause and effect relationship between default events occurring across the plurality of feature-based time series from the feature-based default burst, and outputting feature-based default rules from the corresponding cause and effect relationship. The method further includes predicting an occurrence of a default event and time for a particular client from results of the feature generalization.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a high-level system architecture for post-lending credit management according to an embodiment;

FIG. 2 depicts a process for post-lending credit management according to an embodiment;

FIGS. 3A and 3B depict time series for feature generation using industry as example according to an embodiment;

FIG. 4 depicts a process for temporal sequential pattern mining according to an embodiment;

FIG. 5 depicts an example of an output pattern for post-credit lending management according to an embodiment; and

FIG. 6 depicts a computer system for post-credit lending management according to an embodiment.

### DETAILED DESCRIPTION

Exemplary embodiments provide post-credit lending management for banking customers (also referred to herein as ‘clients’). The post-credit lending management provides early default warning indications by performing sample generalization and feature generalization, as well as sequential pattern learning to assess post-lending credit. The data generalization and serialization marks the events of various types on a time series for each client. The feature generalization includes dimensions, such as industry and geographic region. Default burst patterns are learned, and the projected default time based on the learning is marked on a client time-series. A final default event time prediction with optimal learning is generated which maximizes the number of rules having defaults as their consequences.

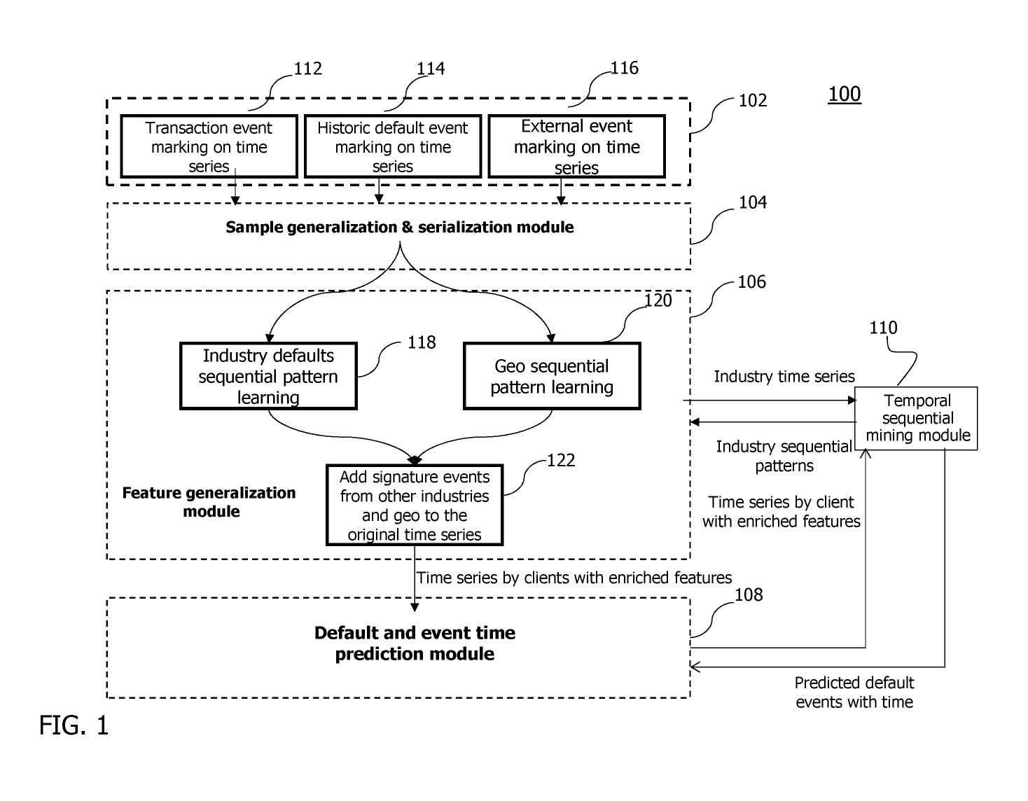

Referring now to FIG. 1, a high-level system architecture 100 for post-credit lending management in accordance with an embodiment is generally shown. The architecture 100 of FIG. 1 includes data sources 102, a sample generalization and serialization module 104, a feature generalization module 106, a default and event time prediction module 108, and a temporal sequential mining module 110. In an embodiment, one or more of the data sources 102 reside externally from the modules 104, 106, 108, and 110, e.g., over one or more networks. In an embodiment, the modules 104, 106, 108, and 110 are implemented by one or more computer devices that are communicatively coupled to one or more of the data sources over the network(s).

The data sources 102 may be physical storage devices containing memory for storing the data residing therein. As shown in FIG. 1, by way of illustration, a first data source 112 stores transaction events associated with clients of an enterprise implementing the post-credit lending management. The transaction events may include, e.g., a receipt of money in the client account, an outflow of money from the client account, as well as values (amounts) of the transactions. The transaction events include some indication or marking of a time, such as a timestamp representing the time the transaction event occurred and/or was recorded via the data source.

A second data source 114 stores historic default events associated with the clients. The historic default events represent any default event that has occurred in the past with respect to credit extended to a client. The credit may be in the form of a loan or credit card or other instrument. The historic default events include some indication or marking of a time, such as a timestamp representing the time the default event occurred and/or was recorded via the data source.

A third data source 116 stores other types of events that are determined to have a potential relationship with the client and/or the client's ability to honor a credit agreement made at any point in the future of the agreement. For example, the third data source 116 may be implemented by a news agency and a related event may be a change in the economic health of an industry. In another example, the third data source 116 may be implemented by a social media network in which information that is posted by various individuals or entities is used to determine whether some event has occurred (e.g., a weather event causes catastrophic damage to a geographic region that may affect the client's ability to honor the credit agreement. Thus, in an embodiment, various types of information can be used in the post-lending credit processes described herein.

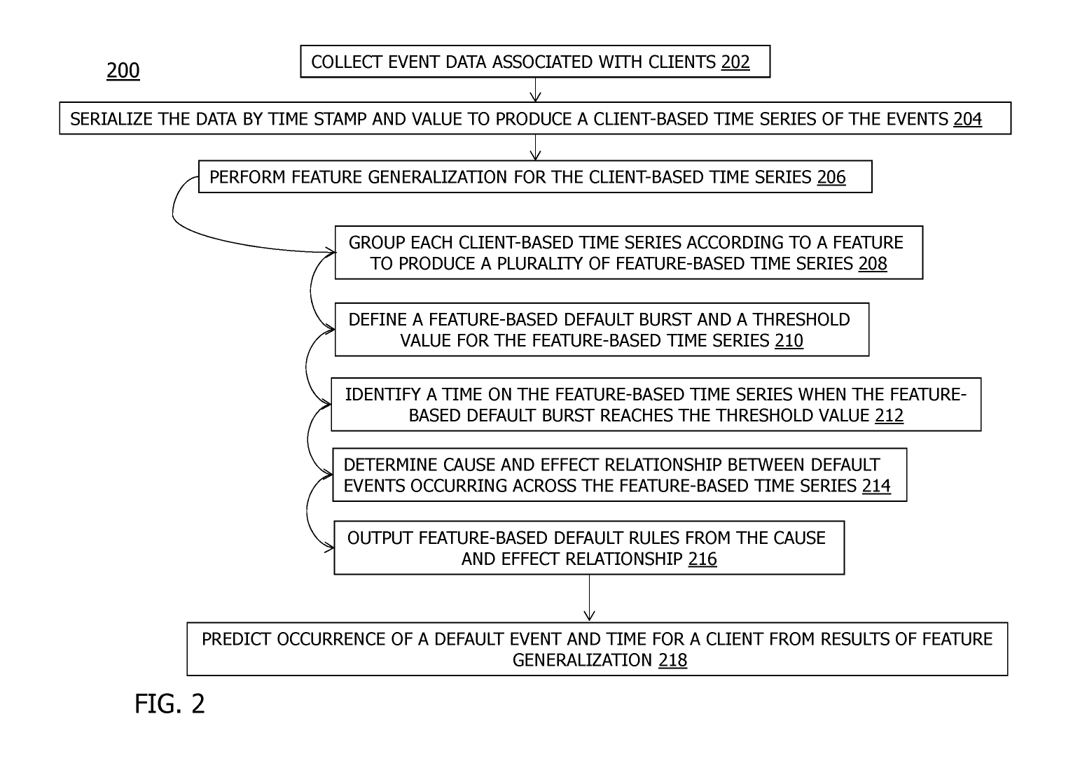

The sample generalization and serialization module 114 collects the data from the data sources 112, 114, and 116, including the timestamp information and serializes the data, as will be described further herein. Once serialized, the feature generalization module 106 enriches the time series data from the module 104 with more features in order to overcome any event sparsity in the time series data. The module 106 determines industry-based defaults and sequential pattern learning 118, as well as geographical sequential pattern learning 120, and adds signature events from other industries in addition to the geographic information to the original time series 122. For example, industries may include real estate, steel, and energy/utility. It is understood that these industries can impact one another. This process is described further in FIG. 2.

The results of the process from module 106 (e.g., industry time series data) is applied to the temporal sequential mining module 110, and results from the module 110 processing includes predicted default events including event times. The results are supplied to the default and event time prediction module, which determines the final prediction for the default event including time by maximizing identified patterns of interest. The default and event time prediction module 108 outputs time series by client with the enriched features from module 106 and provides this data to the temporal sequential mining module 110, which in turn provides the data back to the feature generalization module 106.

Referring now to FIG. 2, a process 200 for post-credit lending management in accordance with an embodiment is generally shown. At block 202, the sample generalization and serialization module 104 collects event data associated with clients. As indicated above, the data collected includes transaction data, historic default event data and external event data from data sources 112, 114, and 116, respectively. The sample generalization and serialization module 104 serializes the data by timestamp and value to produce a client-based time series of the events at block 204. This process is provided to discover inherent temporal rules between transaction/reporting events and default events taking the time intervals into account. In an embodiment, the event data is marked on a time series with the timestamp and value of each event. For example, from the time a loan is approved for a client, a time series for the client may include a first transaction A representing a small amount of money, followed by a second transaction B (at a first time interval) representing a large amount of money, which is then followed by a social media report event C (at a second time interval) representing negative news released in the social media. Following these events, a default event (at a third time interval) is marked on the time series.

At block 206, the feature generalization module 106 receives the time series results from block 204 and performs feature generalization for the client-based time series. In FIG. 2, blocks 208-216 represent substeps of the block 206 as will now be described. The feature generalization module 106 groups each client-based time series according to a feature to produce a number of feature-based time series at block 208. In an embodiment, an approach to generalize the features may include:

Define “industry defaults burst=true if (# of defaults/months/average defaults per month) >threshold;

mark the peak time where industry defaults burst=true;

learn cause and effect relationship between industries by calling ‘temporal sequential pattern mining module.

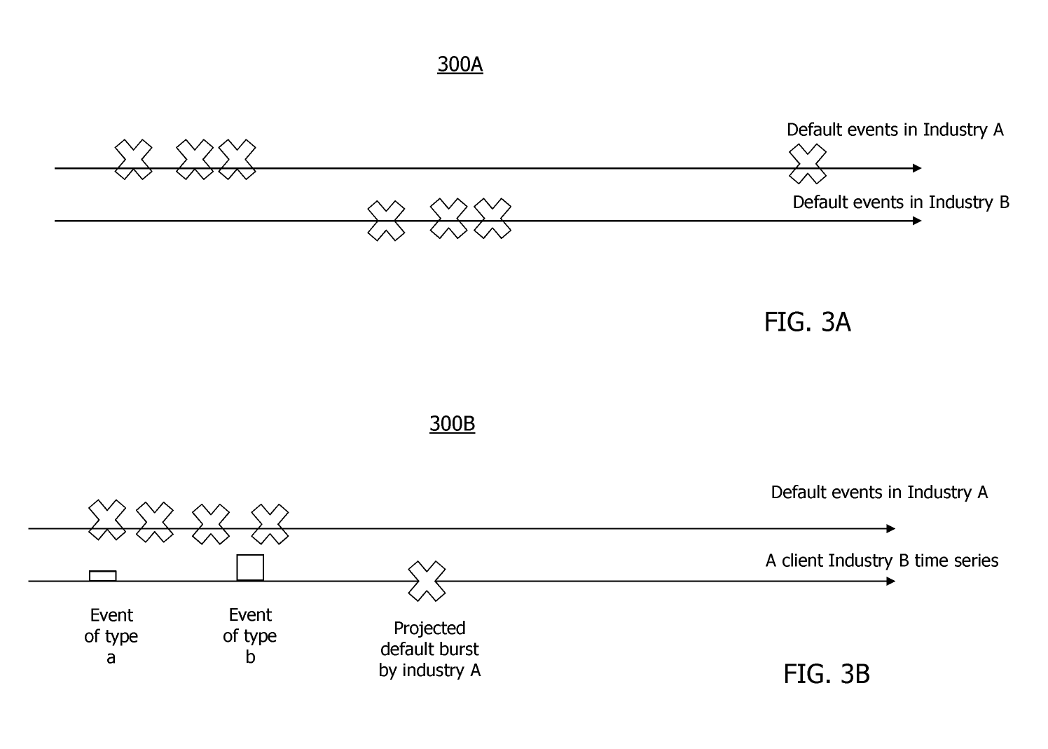

The temporal sequential pattern mining module is described further herein. As shown in FIG. 3A, a time-series 300A using ‘industry’ as the selected feature. The first line, which represents a sequence of time, shows four default events that occurred in the time frame for industry A, while a second line, which represents the same sequence of time, shows three default events for another industry B.

In block 210, a feature-based default burst and threshold value is defined for the feature-based time series, and a time is identified on the feature-based time series when the feature-based default burst reaches the threshold value at block 212. In block 214, a cause and effect relationship between the default events is determined across the feature-based time series. As shown in FIG. 3B, a time-series 300B using industry as the selected feature is shown. The first line shows four default events that occurred in the time frame for industry A, while the second line shows two events (event of type a and event of type b) followed by a projected default burst by industry A. In block 218, the default and event time prediction module 108 predicts the occurrence of a default event and time for a client from results of the feature generalization module 106.

The temporal sequential pattern mining process will now be described. The temporal sequential pattern mining process seeks to maximize the number of rules having ‘default’ as a consequence. The process is based on discretized event values and time intervals and uses minimal vertical support to search frequent patterns. The vertical support of a rule is greatly affected by the discretization algorithm and the number of categories of discretized symbols. For example, the minimal vertical support is set to 0.2, the vertical support of rule: A→Default 0.5, if the time interval or duration is discretized to 2 categories (e.g., short, long) and assume rule: A→Default with duration=short and long have equal support, then both the rule: A→Default with short duration and rule: A→Default with long duration have support 0.25 and are recognized as frequent. Otherwise, if the time duration is discretized into four categories then the rules are not frequent.

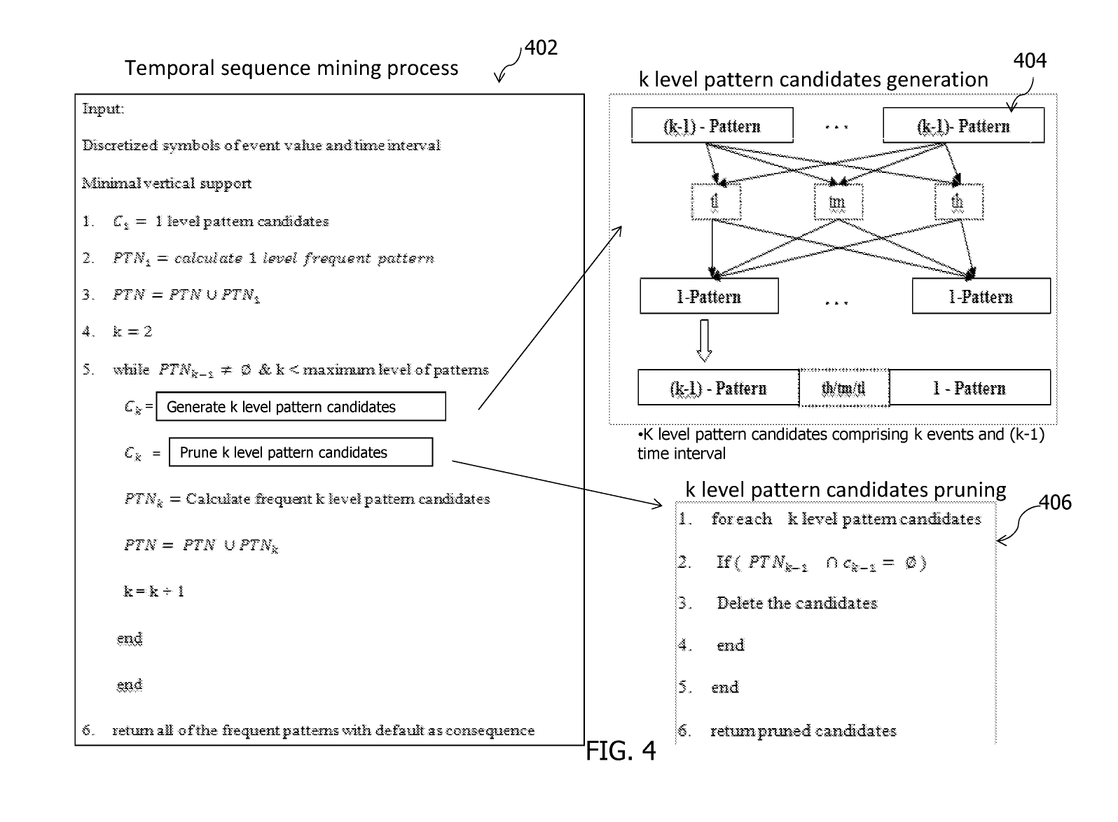

FIG. 4 illustrates an exemplary temporal sequential pattern mining process. As shown in FIG. 4, a temporal sequence mining process 402 is shown in which 4 steps are provided. Before temporal sequence mining, event value and time interval are discretized and a minimal vertical support setted. Then, first level frequent patterns are generated among all of the first level pattern candidates. Thereafter, k level frequent patterns are generated level by level. Finally, all of the frequent patterns with default as a consequence are output.

In step 5, the process includes generating k level pattern candidates, which is further described in subprocess 404. K level pattern candidates are extended from (k−1) frequent patterns by adding one time duration and a 1 level frequent pattern, thus k level pattern candidates comprising k events and (k−1) time duration/interval. In addition, the process includes pruning k level pattern candidates. To reduce the computing cost, k level pattern candidates are pruned before frequent pattern mining. For each of k level pattern candidates, if its sub (k−1) pattern is not frequent, then the candidate is deleted.

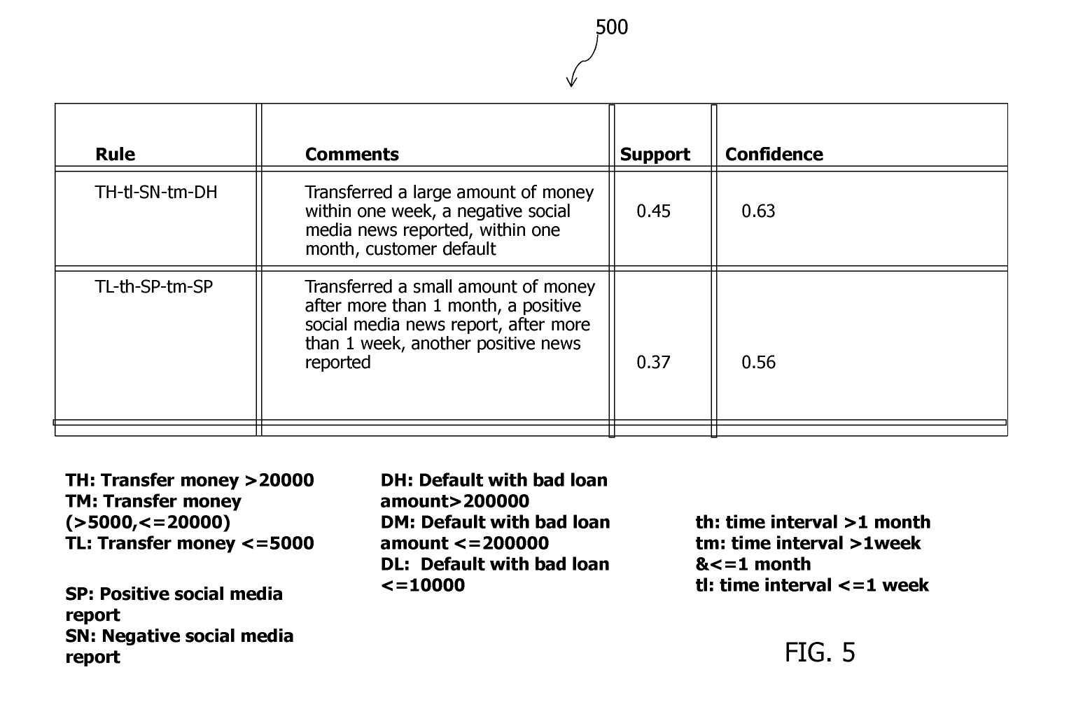

As stated above in FIG. 2, the process includes outputting feature-based default rules from cause and effect relationships (block 216). A sample table 500 shown in FIG. 5 illustrates rules generated from the process. A first column provides the rules, and a second column lists comments that further clarify the rule. For example, as shown in a first record of the table 500, a client transferred a large amount of money (TH), within one week (t1), a social media news reported negative information (SN), within one month's time (tm). The resulting prediction indicates a default greater than $200,000 (DH). The term ‘support’ as used herein refers to vertical support, e.g., the proportion of customers who have the pattern. A confidence value 0.63 indicates that the process is 63% confident that the prediction is accurate. A legend of terms that define the rules is shown below the table 500.

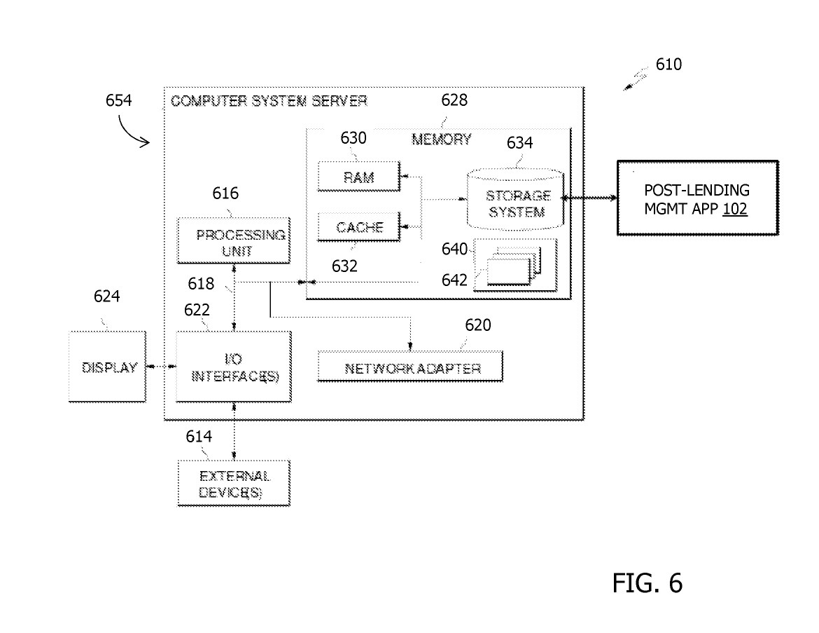

Referring now to FIG. 6, a schematic of an example of a computer system 654 in an environment 610 is shown. The computer system 654 is only one example of a suitable computer system and is not intended to suggest any limitation as to the scope of use or functionality of embodiments described herein. Regardless, computer system 654 is capable of being implemented and/or performing any of the functionality set forth hereinabove.

In the environment 610, the computer system 654 is operational with numerous other general purpose or special purpose computing systems or configurations. Examples of well-known computing systems, environments, and/or configurations that may be suitable as embodiments of the computer system 654 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 654 may be described in the general context of computer system-executable instructions, such as program modules, being executed by one or more processors of the computer system 654. Generally, program modules may include routines, programs, objects, components, logic, data structures, and so on that perform particular tasks or implement particular abstract data types. Computer system 654 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 6, computer system 654 is shown in the form of a general-purpose computing device. The components of computer system 654 may include, but are not limited to, one or more computer processing circuits (e.g., processors) or processing units 616, a system memory 628, and a bus 618 that couples various system components including system memory 628 to processor 616. The processor 616 may be communicatively coupled to one or more networks and computer systems to perform the processing described herein.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 654 typically includes a variety of computer system readable media. Such media may be any available media that is accessible by computer system 654, and it includes both volatile and non-volatile media, removable and non-removable media.

System memory 628 can include computer system readable media in the form of volatile memory, such as random access memory (RAM) 630 and/or cache memory 632. Computer system 654 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. These modules may reflect modules 104, 106, 108, and 110 of FIG. 1. Each of the operating system, one or more application programs, other program modules, and program data or some combination thereof, may include an implementation of a networking environment. Program modules 642 generally carry out the functions and/or methodologies of embodiments of the invention as described herein. An example application program or modules is depicted in FIG. 6 as post-lending credit management application 602. Although the post-lending credit management application 602 is depicted separately, it can be incorporated in any application or module. The post-lending credit management application 602 can be stored directly in the memory 628 or can be accessible by the processor 616 from a location external to the computer system 654.

Computer system 654 may also communicate with one or more external devices 614 such as a keyboard, a pointing device, a display device 624, etc.; one or more devices that enable a user to interact with computer system 654; and/or any devices (e.g., network card, modem, etc.) that enable computer system 654 to communicate with one or more other computing devices. Such communication can occur via input/output (I/O) interfaces 622. Still yet, computer system 654 can communicate with one or more networks such as a local area network (LAN), a general wide area network (WAN), and/or a public network (e.g., the Internet) via network adapter 620. As depicted, network adapter 620 communicates with the other components of computer system 654 via bus 618. It should be understood that although not shown, other hardware and/or software components could be used in conjunction with computer system 654. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include providing post-credit lending management for banking customers that includes early default warning indications by performing sample generalization and feature generalization, as well as sequential pattern learning to assess post-lending credit. The data generalization and serialization marks the events of various types on a time series for each client. The feature generalization includes dimensions, such as industry and geographic region. Default burst patterns are learned, and the projected default time based on the learning is marked on a client time-series. A final default event time prediction with optimal learning is generated which maximizes the number of rules having defaults as their consequences.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
collecting, via computer processor, data associated with events for each of a plurality of clients, each of the events associated with a corresponding one of the plurality of the clients;
serializing, for each of the plurality of clients, the data by time stamp and value to produce a client-based time series of the events;
performing, via the computer processor, feature generalization for the client-based time series, comprising:
grouping each of the client-based time series according to a selected feature to produce a plurality of feature-based time series;
defining a feature-based default burst and a threshold value for the feature-based time series;
identifying a point in time on the feature-based time series when the feature-based default burst reaches the threshold value;
determining a cause and effect relationship between default events occurring across the plurality of feature-based time series from the feature-based default burst, and execution of a temporal sequential mining module, the temporal sequential mining module discretizing default event values and time intervals, and searching for patterns using a designated vertical support, wherein execution of the temporal sequential mining module further includes:
generating first level frequent patterns among all of the first level pattern candidates; and
generating k level frequent patterns by level;
outputting feature-based default rules from the corresponding cause and effect relationship; and
predicting, via the computer processor, an occurrence of a default event and time for a particular client from results of the feature generalization.

2. The method of claim 1, wherein the client is a banking consumer and the events include transaction events and historic default events with respect to credit extended to the clients.

3. The method of claim 1, wherein the client is a banking consumer and the events include external events comprising at least one of news reports and social media data.

4. The method of claim 1, wherein the selected feature comprises one of an industry and a geographic region associated with the client.

5. (canceled)

6. The method of claim 1, further comprising determining a confidence value of a predicted default event.

7. The method of claim 1, wherein the client is a banking consumer subject to a loan, and the events include post-lending events.

8. A system, comprising:
a memory having computer readable instructions; and
a processor for executing the computer readable instructions, the computer readable instructions including:
collecting data associated with events for each of a plurality of clients, each of the events associated with a corresponding one of the plurality of the clients;
serializing, for each of the plurality of clients, the data by time stamp and value to produce a client-based time series of the events;
performing feature generalization for the client-based time series, comprising:
grouping each of the client-based time series according to a selected feature to produce a plurality of feature-based time series;
defining a feature-based default burst and a threshold value for the feature-based time series;
identifying a point in time on the feature-based time series when the feature-based default burst reaches the threshold value;
determining a cause and effect relationship between default events occurring across the plurality of feature-based time series from the feature-based default burst, and execution of a temporal sequential mining module, the temporal sequential mining module discretizing default event values and time intervals, and searching for patterns using a designated vertical support, wherein execution of the temporal sequential mining module further includes:
generating first level frequent patterns among all of the first level pattern candidates; and
generating k level frequent patterns by level;
outputting feature-based default rules from the corresponding cause and effect relationship; and
predicting an occurrence of a default event and time for a particular client from results of the feature generalization.

9. The system of claim 8, wherein the client is a banking consumer and the events include transaction events and historic default events with respect to credit extended to the clients.

10. The system of claim 8, wherein the client is a banking consumer and the events include external events comprising at least one of news reports and social media data.

11. The system of claim 8, wherein the selected feature comprises an industry.

12. The system of claim 8, wherein the selected feature comprises a geographic region associated with the client.

13. The system of claim 8, wherein the computer readable instructions further include determining a confidence value of a predicted default event.

14. The system of claim 8, wherein the client is a banking consumer subject to a loan, and the events include post-lending events.

15. A computer program product comprising a computer readable storage medium having program instructions embodied therewith, the program instructions executable by a processor to cause the processor to perform:
collecting data associated with events for each of a plurality of clients, each of the events associated with a corresponding one of the plurality of the clients;
serializing, for each of the plurality of clients, the data by time stamp and value to produce a client-based time series of the events;
performing feature generalization for the client-based time series, comprising:
grouping each of the client-based time series according to a selected feature to produce a plurality of feature-based time series;
defining a feature-based default burst and a threshold value for the feature-based time series;
identifying a point in time on the feature-based time series when the feature-based default burst reaches the threshold value;
determining a cause and effect relationship between default events occurring across the plurality of feature-based time series from the feature-based default burst, and execution of a temporal sequential mining module, the temporal sequential mining module discretizing default event values and time intervals, and searching for patterns using a designated vertical support, wherein execution of the temporal sequential mining module further includes:
generating first level frequent patterns among all of the first level pattern candidates; and
generating k level frequent patterns by level; and
outputting feature-based default rules from the corresponding cause and effect relationship; and
predicting an occurrence of a default event and time for a particular client from results of the feature generalization.

16. The computer program product of claim 15, wherein the client is a banking consumer and the events include transaction events and historic default events with respect to credit extended to the clients.

17. The computer program product of claim 15, wherein the client is a banking consumer and the events include external events comprising at least one of news reports and social media data.

18. The computer program product of claim 15, wherein the selected feature comprises an industry.

19. The computer program product of claim 15 wherein the selected feature comprises a geographic region associated with the client.

20. The computer program product of claim 15, wherein the program instructions are further executable to perform determining a confidence value of a predicted default event.

21. (canceled)
